(19) United States
(12) Patent Application Publication
(10) Pub. No.: US 2007/0157504 A1
(43) Pub. Date: Jul. 12, 2007

(54) Decoy with protective coating

(76) Inventor: Barry Nelson, Spicer, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/328,349

(22) Filed: Jan. 9, 2006

(51) Int. Cl. A01M 31/06

(52) U.S. Cl. 43/3

(57) ABSTRACT

Described are game decoys and methods of preparing game decoys, the decoys including a polymeric coating that improves durability of the decoy.

### FIELD OF THE INVENTION

The invention relates to decoys and in particular protective coatings which are applied to game decoy bodies. The protective coating comprises an elastomeric polymeric material. Preferred polymeric materials can be derived from isocyanate materials (e.g., monomers, pre-polymers, polymers, etc.) and may be applied by spraying to a decoy body. Preferred sprayable polymeric coatings may be high solids (e.g., 100 percent solids) as applied, can be derived from isocyanate monomer, and may most preferably be applied and dried to form a protective coating that provides properties of strength, toughness, and durability of the decoy body to which the coating is applied.

### BACKGROUND

For hunters who use decoys to attract game, durability of a decoy is essential. Decoys are often handled aggressively by throwing onto a field, into a pickup bed or storage area of a sport-utility vehicle or car, into a bag containing other decoys, or by being accidentally hit by shotgun fire. This aggressive handling can cause the decoys to be structurally broken, resulting in lost body parts such as a bill, head, neck, or tail, or by a loss of buoyancy. The cost of decoys can be significant, up to and exceeding several hundreds of dollars per dozen. Hunters wish to avoid damage to decoys to avoid replacement costs. Also important is that upon arriving at a hunting location a hunter does not want to find decoys that have become broken and unusable. It is inconvenient to repair decoys in the field. For floating decoys, durability is important to avoid having decoys lose buoyancy and sinking and becoming lost, e.g., if accidentally damaged or shot during use. For field decoys, a decoy that is shot may no longer mimic the game being attracted due to loss of body parts such as a head, tail, or neck.

Currently, various types of decoys are available, including foam, cork, wood, and plastic decoys. These can exhibit various deficiencies in durability properties. In particular, decoys of foam and cork can be easily broken, especially at extended body portions such as the bill, head, neck, and tail. If broken a head may be replaced, but this can be expensive and time consuming, and a more durable decoy that would not break in the first place would be preferred over a decoy that could be fixed if broken. Many plastic decoys are hollow and can easily lose buoyancy upon being damaged.

### SUMMARY

The invention relates to game decoys and in particular to protective coatings applied to game decoy bodies. The protective coating comprises an elastomeric polymeric material. Preferred polymeric materials can be derived from an isocyanate material such as an isocyanate monomer, polymer, or pre-polymer, and may be applied by spraying to a decoy body. Preferred sprayable polymeric coatings may be high solids (e.g., 100 percent solids) as applied, can be derived from an isocyanate material, and may most preferably be applied and dried to form a protective coating that provides properties of strength, toughness, and durability of the decoy to which the coating is applied.

Decoys of the invention may be for fowl such as waterfowl, including geese or ducks, or may be for turkey, or for any other land, field, lake, sea, or other game or non-game animal as desired. The decoy may be buoyant and for use in water such as with a duck or a goose decoy, or may be for use on land, such as with goose and turkey decoys. The decoy body may be assembled from multiple pieces or parts of cork, wood, or foam, often from parts that include one or more separate body pieces, a headpiece.

Decoys of the invention include a decoy body that is partially or completely coated with a polymer that comprises elastomeric polymer, the coating improves durability and resistance to physical damage.

In one aspect the invention relates to a game decoy that includes a decoy body having a shape of a game animal, and coating on the body comprising elastomeric polymer.

In another aspect the invention relates to a method of preparing a game decoy. The method includes: providing a decoy body having a shape of a game animal, providing a liquid polymeric composition that can harden to a polymeric coating that includes and elastomer; and applying the liquid polymeric composition onto the body and allowing the polymeric composition to harden as a polymeric coating.

### BRIEF DESCRIPTION OF THE DRAWINGS

FIG. 1 is a side cut-away view of a coated decoy of the invention.

FIG. 2 is a rear cut-away view of a coated decoy of the invention.

FIG. 3 is a side cut-away view of a coated decoy of the invention.

FIG. 4A is a bottom view of a decoy piece.

FIG. 4B is a side view of assembled decoy pieces.

FIG. 4C is a side view of assembled decoy pieces.

FIG. 5A is a bottom view of a decoy piece.

FIG. 5B is a bottom side of a decoy piece.

FIG. 5C is a side view of assembled decoy pieces.

FIG. 5D is a rear view of assembled decoy pieces.

All drawings are schematic and not to scale, and are not intended to limit the invention.

### DETAILED DESCRIPTION

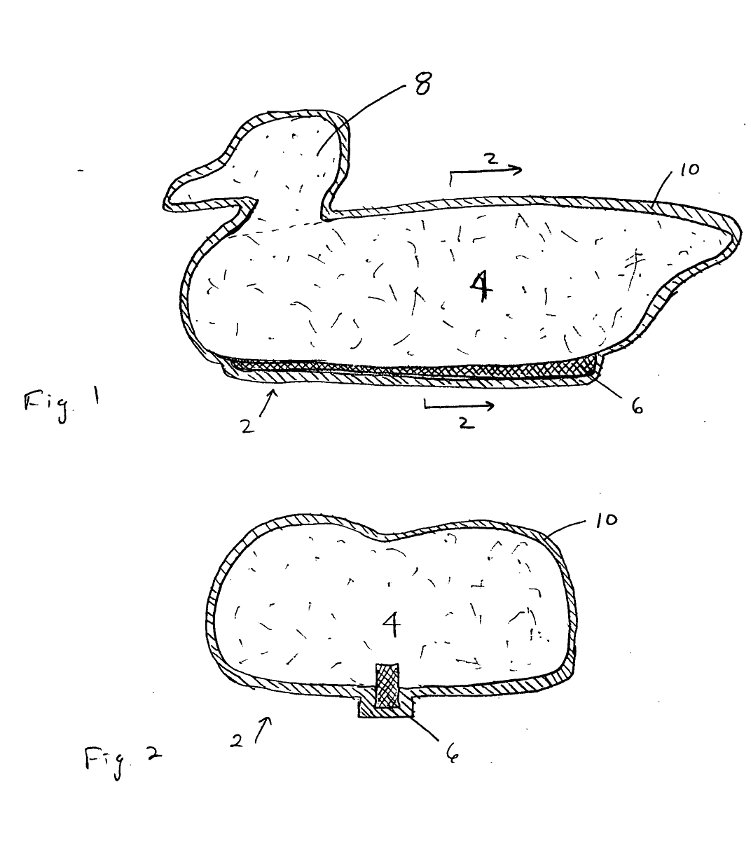

Referring to FIG. 1, a decoy 2 can include a decoy body comprised of a body piece 4, a headpiece 8, and optional keel 6. The decoy of the invention includes a protective coating 10 on at least a portion of the outer surface of the decoy body.

Pieces of a decoy body, such as body piece 4 or headpiece 8 can be formed from any suitable material such as a buoyant material, e.g., a cellular polymeric material, including open-cell polymeric foam materials, closed cell polymeric foam materials, cellular thermosetting and thermoplastic materials; wood; cork (either high-density cork or low-density cork); and other materials such as buoyant materials known to be useful for waterfowl or other types of decoys. Accordance to certain inventive decoys, a body piece 4 and head piece 8 can be formed of cellular expanded polystyrene beads wherein the resulting material has a density of about 4 pounds per cubic foot; high or low density cork; wood; or another type of polymeric foam such as polyurethane foam. FIG. 2 shows a cross-sectional view of coated decoy 2, from the back.

Coating 10 comprises elastomeric polymer, and preferably consists of or consists essentially of elastomeric polymer, e.g., is made up of greater than 50 percent by weight elastomeric polymer, greater than 60 percent by weight elastomeric polymer, or greater than 70, 80, 90, or 95 percent by weight elastomeric polymer. As used in the present description the term “elastomeric” refers to polymeric substances that possess the quality of elasticity, e.g., the ability to regain shape after deformation such as by elongation by stretching.

Elastomeric polymers are known in the chemical and polymer arts and according to the invention can be any elastomeric polymer that will provide useful properties as a coating on a decoy as described herein, and that can be processed to adhere to a decoy body. Elastomeric polymers include rubbers such as natural rubbers; elastomeric polymers derived from isocyanate materials (e.g., monomers) such as a polyurethane, a polyurea, or a combination of a polyurea and a polyurethane; an epoxy polymer; a polyacrylate; or a combination of one or more of these.

Polyurethanes and polyureas are materials and coatings made with isocyanate compounds (e.g., monomers, oligomers, pre-polymers, polymers, etc.) containing multiple isocyanate (NCO—) moieties (a “polyisocyanate” compound), e.g., two isocyanate moieties, which compound is referred to as a diisocyanate. An isocyanate can be combined and react with a material that includes one or multiple reactive hydrogens, such as a compound (e.g., monomer, oligomer, pre-polymer, polymer, etc.) that includes one or multiple alcohol or amine moieties, e.g., a polyol or a poly-amine-functional compound such as a diamine. A polyurethane is a polymer made by the condensation reaction between a polyisocyanate and a hydroxyl-containing material such as a polyol. A polyisocyanate can react with a multi-amine-functional compound to produce a polyurea. Exemplary polyureas are prepared by reacting a diisocyanate (e.g., MDI) with amine-terminated polyethers.

An isocyanate compound may be a low or very low molecular weight compound or higher molecular weight prepolymer or polymer. The compound or backbone of an oligomer, polymer, or prepolymer may be of any desired chemistry, such as aliphatic, aromatic, polyether, etc. Examples of a diisocyanates useful to prepare polyurethane materials include methylene-4,4′-dipyenyl diisocyanate (MDI) and diphenylmethane diisocyanate.

A polyol or poly-functional amine compound may be a low or very low molecular weight compound or higher molecular weight prepolymer or polymer. The base compound or backbone of an oligomer, polymer, or prepolymer may be of any desired chemistry, such as aliphatic, aromatic, polyether, etc. Exemplary polyols include polyether polyols. Exemplary poly-functional amine compounds include aromatic diamines.

The coating composition or a precursor liquid coatable material may include elastomeric polymer and may additionally include additives such as fillers, pigments or other coloring agents, plasticizers, surfactants, flow agents, molecular scavengers to inhibit moisture contamination, anti-oxidants to reduce oxidation, anti-foaming agents, etc., as will be known in the arts of elastomeric polymers and polymeric coatings. Exemplary and preferred polymeric compositions useful for spray-on application can include no abrasive fillers and reduced organic solvent and water levels (e.g., less than 5 percent organic solvents or water).

The decoy coating may be derived from a liquid (flowable) polymeric composition, which may be of any form and composition capable of producing a hardened coating containing an elastomeric polymer as described herein. A liquid polymeric composition may be solventless (100 percent solvent), water-based, solvent-based, curable, thermoplastic, thermosetting, etc., such as a one-part or two-part liquid polymeric composition that can be applied to a decoy body and then cure, set, or otherwise harden to form a coating on a partial or entire surface of the decoy body.

The coating provides desired mechanical properties for use in a game decoy such as one or more of good durability, prevention of breakage of extended portions of a decoy, and maintained buoyancy in the event that a coated decoy should become damaged. The polymeric coating material can be applied as a liquid to a decoy body and then chemically or thermally cured or otherwise hardened, for example by chemical action that includes crosslinking or polymerization, e.g., reaction of an isocyanate group with an alcohol or amine. Desired properties of the liquid polymeric material can include flow properties that allow for application by a practical method such as by spraying, dipping, or brushing, and in particular by spraying. Another desired property of the elastomeric polymer, for desirable coating properties, can be relatively rapid cure or hardening to a tack-free coating.

The polymeric coating upon curing or hardening can preferably exhibit one or more of: mechanical hardness with flexibiltiy, resistance to water over prolonged exposure, low porosity; mechanical properties such as elasticity, flexibility (as opposed to brittleness), and modulus to withstand impact between decoys when decoys are handled and avoid breakage of extended portions of a decoy such as a neck, head, bill, or tail. Depending on the thickness of the coating a hardened coating may be sufficiently thick and flexible to be sufficiently impact resistant to withstand shotgun fire, preferably without penetration through the coating. If the coating is not sufficiently impact resistant to withstand penetration of shotgun fire, exemplary decoys of the invention may still remain intact in the shape and form of a decoy, and buoyant after receiving shotgun fire; this may be due to a buoyant decoy body below the coating.

Exemplary materials for use as a decoy coating as described herein include but are not limited to polymeric materials used as spray-on truck bed liners, as well as polymeric compositions having similar mechanical properties during coating and after coating to a substrate. Exemplary products currently available for use as truck bed liners, that are also useful for a decoy coating of the invention, include those sold commercially under the trade name TUFF STUFF® and DuraSpray®, from Rhino Linings®, headquartered in San Diego Calif.; LINE-X® bed liners from LINE-X® of Southern California; ULTIMATE bed liners from ULTIMATE LININGS, Houston Tex.; and the SPEEDLINER® line of truck bed liners including SPEEDLINER® 1000 from Industrial Polymers Incorporated, Houston Tex., as well as other polymeric materials from Industrial Polymers Incorporated available under the trade name StyroSpray®, e.g., StyroSpray® 715 and StyroSpray® 500; as well as other similar polymeric coating compositions that are presently available or that may become available in the future. These materials are polymeric, elastomeric, e.g., polyether polyurethanes, which can be applied as a liquid by combining a two-part 100 percent solids system and spraying to form a coating. These sprayable, 100 percent solids systems can be preferred for use as decoy coatings because of the ability to be applied by spraying, quickly hardening, and also due to their desirable mechanical properties; however, other polymeric materials that contain elastomeric polymer and that exhibit similar mechanical properties in an applied coating can also be also used for a decoy coating of the invention, whether or not based on isocyanate chemistry, whether or not 100 percent solids, and whether or not capable of being applied by spraying.

Preferred polymeric bedliner materials can take the form of an uncured combination of two liquid parts (e.g., an isocyanate part and a “resin” part) that can be combined and sprayed onto a surface of a decoy body to coat all or a portion of the surface; top and side surfaces of a floating decoy are preferably coated and a bottom surface is optionally and preferably coated but need not be coated; for other animals such as a goose or turkey, at least exposed top and side surfaces may be coated, and bottom surfaces may optionally and preferably be coated. Upon mixture and application, the mixture of two polymeric liquids forms a coating and hardens rapidly to result in a decoy coating having desirable mechanical properties that provide durability for decoys. The two-part liquid composition can include low levels of organic solvent, e.g., may be 100 percent solids, and may cure to form a hardened elastomeric polyurethane or polyurea.

Exemplary two-part sprayable compositions can optionally and preferably be coated without forming run-marks, drips, or sags, on vertical surfaces, and to produce a smooth, uniform, and even coating finish. For instance, certain two-part spray on bedliner materials can be sprayed to a decoy body and may be hardened and tack-free to the touch within 1 minute, preferably in less than 30 seconds, or even less than 10, 5, or 3 seconds, and can therefore be sprayed to a decoy body to form a sag-free and run-free, smooth and even surface over the decoy body surface including vertical surfaces. The sprayable composition may typically be sprayed to a thickness of up to or exceeding 1 or 2 millimeters per “layer” or “pass,” and multiple layers or passes may be successively applied to a decoy surface to produce any desired total thickness, e.g., from 1 to 10 millimeters or from 2 to 8 millimeters. The coating may be applied more heavily to portions of the decoy body that are particularly sensitive to damage with aggressive handling such as at the bill (including underneath the bill), at the neck and head, at the tail, at a seam between a neck and a main body in decoys that include a replaceable headpiece, or at any other extension or seam.

Also preferably, a hardened coating may be capable of being painted, meaning that a latex or oil-based paint may be applied to the polymeric coating and will adhere to the hardened coating to produce a durable painted decoy. Additionally, preferred coatings can exhibit high inter-laminar adhesion and strength to allow for good adhesion between multiple layers.

Preferably, a liquid polymeric composition may be a solventless two-part isocyanate-based system prepared from two separate liquid polymeric materials that are combined to form a liquid polymeric mixture that can be applied to a decoy as a coating. The applied polymeric composition then cures, sets, or otherwise solidifies to form a hardened coating on the surface of the decoy body having desired mechanical properties. Exemplary isocyanate-based systems may be two-part sprayable products of low solvent levels (e.g., less than 5 percent solvent, or 100 percent solids), which are fast curing and may not contain solvent or abrasive filler, and combine to produce a semi-rigid polyurethane coating, such as a polyether polyurethane. Exemplary solventless two-part sprayable systems can be coated at greater thicknesses compared to solvent-based systems, do not require drying time between coatings, do not exhibit significant sagging or running on vertical surfaces, and do not chemically attack coated surfaces such as cork, foam, or wood.

Useful mechanical properties of a hardened coating (such as a two-part sprayable polymeric elastomer, or other elastomeric polymeric coating) can include one or more of the following, alone or in any combination:

| Shore A Hardness | 80 to 95 A (50D) |
|---|---|
| (ASTM-D 2440) | E.g., 88-92 A (50D) |
| Tensile Strength | 2200 psi (pounds per square inch) |
| (ASTM-D 412) | E.g., 2000 to 5000 psi |
| Elongation at Break | 200% to 600% |
| (ASTM-D 412) | E.g., 230% to 500% |
| Tear Strength | 430 psi |
| (ASTM-D 624) | E.g., 400 to 900 psi, |
| | e.g., 400 to 500 psi; |
| Taber Abrasion (CS-17 wheel) | 24 milligram |
| (ASTM-D 4060) | (mg loss per 1000 cycles) |
| Water Absorption (ASTM-D 570) | |
| 24 hours at 20 degrees Celsius | 0.3% |
| 21 days at 80 degrees Celsius | 3.1% |

Preferred coatings can exhibit a combination of two or more of these properties, such as an “Elongation at Break” within the recited range, a Shore A Hardness within either recited range, alternately or additionally also in combination with a Tensile Strength, Tear Strength, and Water Absorption properties within the recited range.

Density of a coating of the invention, e.g., a coating also used or useful as a vehicle bedliner, can vary depending on factors such as the chemistry and porosity of the coating. A coating such as those used in sprayable polyurethane truckbed liner applications may be within a range of densities below and above 1 gram per cubic centimeter, depending on porosity, application technique, and desired properties. Exemplary such coatings may be sprayed to a density of about 0.75 pounds per square foot at a thickness of ⅛ inch (72 pounds per cubic foot, or 1.16 grams per cubic centimeter), or to a density of about 1 pound per square foot for a ¼ inch coating (48 pounds per square foot, or 0.77 g/cc). Exemplary coatings of the invention may be relatively non-porous, and may exhibit any useful density, such as a density of greater than 0.9 grams per cubic centimeter (g/cc) e.g., a density of from 0.9 to 1.5 g/cc, such as from 1.0 to 1.3 grams per cc.

A coating comprising an elastomeric polymer as described may be applied to a decoy body by any coating method depending on factors such as the type of polymeric material, the level of organic solvent or water contained in a coatable liquid polymeric material, drying time, temperature requirements, etc. Useful equipment for coating polymeric materials to a substrate is commercially available.

For a coating derived from a two-part solventless polymeric system, useful spray equipment is known and commercially available. Examples of equipment may include a single motor driving two separate fixed-ratio proportioning pumps. The pump can deliver a desired ratio of amounts of two liquid materials that are rapidly curable when combined (e.g., a liquid isocyanate part and a liquid “resin”). The two parts are delivered separately into a mixer such as a static mixing tube. The liquids may be delivered by any spray mechanism such as air-assisted spray, airless spray, or pour applications, to yield a solvent-free, 100 percent solids polymeric coating. The separate parts may optionally be heated prior to or during mixing. Preferred materials are sprayed to a quick-curing solvent-free composition that cures to a tack-free surface in a very short time, e.g., less than 60 seconds, often less than 10 seconds or less than 5 seconds. Multiple layers may be applied with little time between passes, to produce a decoy coating of any desired thickness.

The separate parts of a solventless two-part isocyanate-based system (e.g., polyurethane, such as a polyether polyurethane) may be provided at an application temperature that may depend on the particular chemistry of the polymeric system, e.g., at least 60 degrees Fahrenheit, or up to 80, 120, or 140 degrees Fahrenheit. Two parts of material are mixed in amounts that depend on the particular formulation and chemistry, e.g., 1:3, 1:2, 1:1, etc., by volume or weight. Mixed and optionally heated 100 percent solids, two-part materials, can be applied and do not need to dry but may rapidly harden by chemical polymerization or other curing mechanism, e.g., within 60 seconds, 30 seconds, or 10 seconds.

A decoy body may be of any composition, size, and shape useful to attract game, and that has a surface that can accept a coating as described. Useful shapes can be of a duck of various breeds and sizes, a wild turkey, a goose, etc. The decoy may optionally be assembled from two or more pieces such as a head, neck, multiple body pieces, a single main body piece, a tail piece, etc. According to certain embodiments, a decoy body may include a hollow center, which may reduce weight and improve buoyancy. A hollow interior space may be achieved by carving a center of a decoy, or by assembling a decoy from multiple pieces, such as multiple horizontal strata, with one or more horizontal strata of an assembly including a hollow interior to produce a closed hollow interior of the decoy. The size may be actual size of a duck, goose, or turkey, or an enlarged size.

An example of a duck decoy may have a duck shape made from pieces that include a headpiece and a body piece or multiple body pieces. The headpiece may be secured to one or more body pieces by any securement mechanism, such as a nut and bolt extending from the head down through an aperture in the one or more body pieces. Alternately, pieces of a decoy may be adhered together by adhesive, such as a water-based wood glue, for example Elmer'S™ wood glue.

A decoy body may have any combination of dimensions measured at maximum distances of length, width, and height (not including the head, tail, or a keel, if any), such as for a duck decoy: about 15″ (inches)×7″×5″; alternately 17″×11″×7″; alternately 23″×13″×7″. Larger or smaller dimensions may be useful depending on the game animal and breed and depending on if the scale is approximately lifesize or greater than lifesize.

Exemplary decoy bodies may be of high or low density cork; wood; any form of open-cell or closed-cell polymeric foam such as Styrofoam, polyurethane, high-density polyurethane, etc., as are useful with game decoys. The decoy may optionally include a weighted keel, which may or may not be coated along with the body of the decoy. Also optionally, a decoy may include added features such as an attachment for a line or anchor, or a mechanical feature such as a motor for propulsion or moveable wings that may or may not be coated as described.

The body may be solid, continuous, or may include a hollow center, and may optionally be of a buoyant material, especially for decoys intended to float. The decoy body may be coated on all top and side surfaces and may optionally and preferably be coated on the bottom surface.

Extensions of a decoy such as legs, tail, and the neck, head, or bill, may exhibit relatively greater fragility relative to the main body portion (i.e., back, sides, and front below the head). This can be especially true of foam decoys that are constructed by assembly of two separate pieces including a main body piece and a replaceable headpiece. To improve durability of a relatively fragile portion such as a bill or a connection or seam between a neck and a body, the decoy may be coated to a greater thickness on the head, neck, tail, bill, or leg portions; a total coating thickness at these portions may be at least 3 millimeters, at least 4 millimeters, or greater than 5 millimeters, such as from 3 to 10 millimeters or 4 to 6 millimeters.

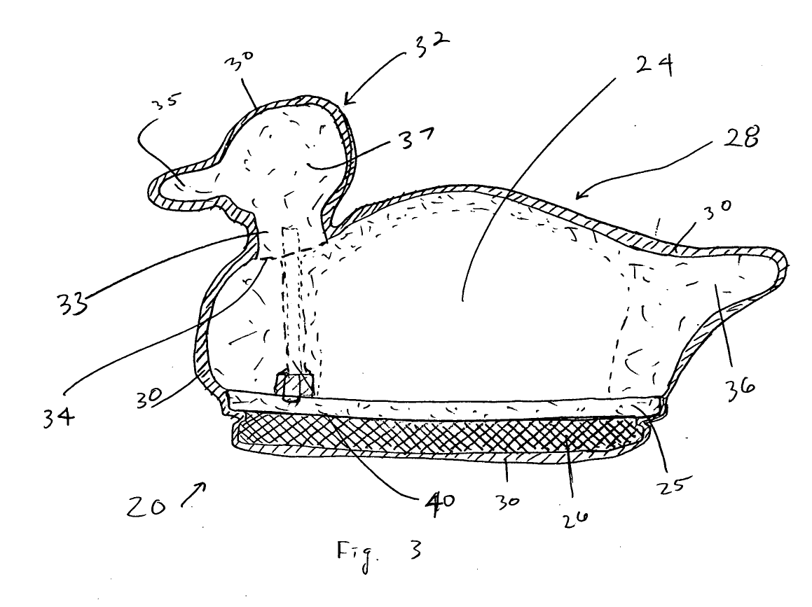

An exemplary decoy design is shown at FIG. 3. Decoy 20 includes buoyant main body piece 28 having hollow center 24. Main body piece 28 can be of a buoyant decoy material such as wood, a cork, a foam such as Styrofoam or a polyurethane, etc. Headpiece 32 is a separate piece that includes neck 33, bill 35, and head portion 37. Neck 33 of headpiece 32 connects to main body 28 at seam 34. Bolt and nut assembly 40 secures headpiece 32 to main body piece 28. Main body piece 28 includes hollow center 24 and tail 36. Decoys of the type that include a main body piece 28 (hollow or otherwise) and a separate replaceable headpiece 32, in Styrofoam or cork (but uncoated), are commercially available from suppliers such as Cabela's, of Oshkosh Nebraska. Removable headpiece 32 is designed to be replaceable if the head of the decoy becomes damaged or broken off during use, which is not uncommon.

Decoy 20 further includes optional bottom piece 25 with optional keel 26, bottom piece 25 being in contact with the underside of main body piece 28. Bottom piece 25 contacts the bottom perimeter surface of main body piece 28 and partially defines hollow center 24. Bottom piece 25 can be secured to main body 28 by mechanical fastener or by adhesive, or the like.

All pieces of decoy 20, including main body piece 28, headpiece 32, optional bottom piece 25, and optional keel 26, once assembled, are shown to be coated and covered with coating 30. This coating of the entire surface mechanically secures the pieces together. Especially desirable is that headpiece 32 is mechanically secured to main body 28, to provide strength, durability, and to prevent breaking of decoy 20 where headpiece 32 meets main body piece 28 at seam 34. A relatively thicker layer of coating 30 may optionally be applied at seam 34 to provide desired strength, such as a coating of at least 3 or 4 millimeters, e.g., at least 5 millimeters. Additionally, neck 33, bill 35, and tail 36, may be coated for added strength, e.g., to a coating of at least 3, 4, or 5 or more millimeters. After coating decoy 20 with coating 30, headpiece 32 is no longer replaceable but is much less susceptible to being damaged during use. Coating 30 over main body piece 28 may be of any thickness, e.g., at least 1 millimeter, at least 2 millimeters, or up to or exceeding 3, 4, or 5 millimeters.

FIG. 3 shows a duck decoy, but other decoys of the invention can be shaped to mimic other game animals such as turkey and geese. Turkey and gees decoys may also be assembled from multiple pieces such as a main body piece, a separate tail piece (not shown in the duck of FIG. 3), a head piece, a longer neck for a goose, etc.

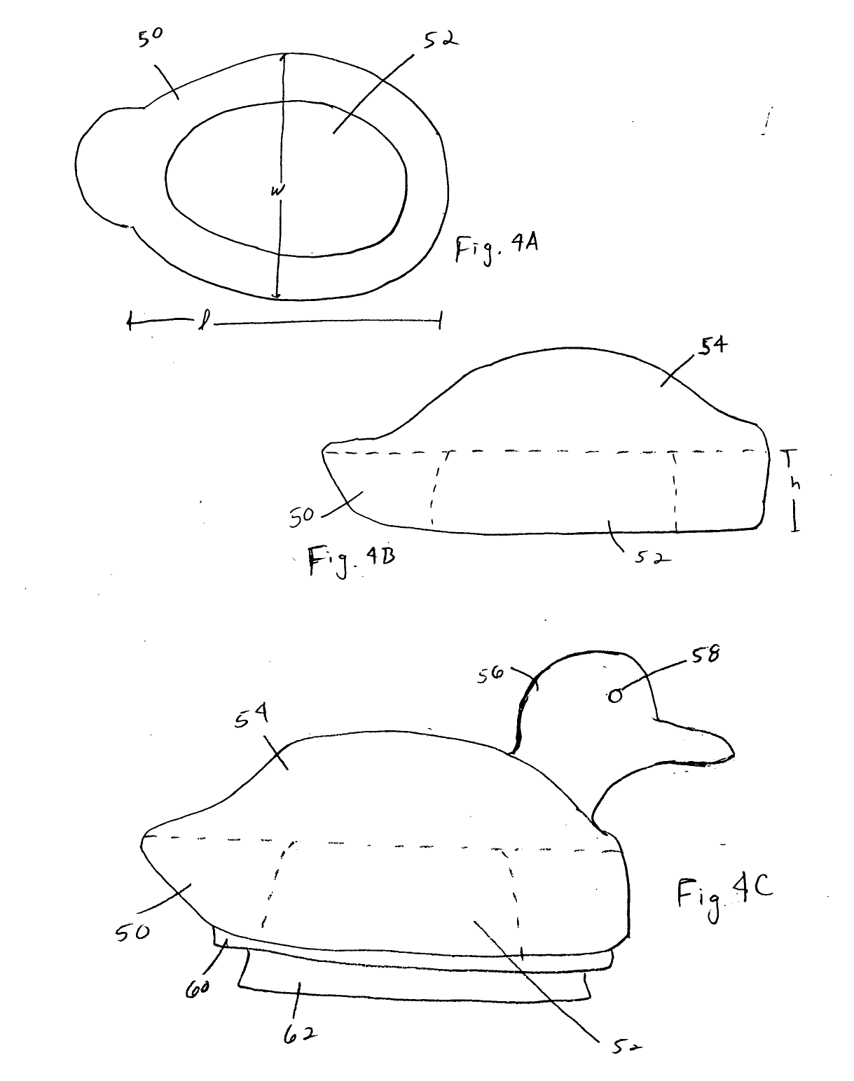

FIGS. 4A, 4B, 4C, and 4D illustrate various views of another embodiment of a decoy assembled from multiple separate pieces. Each piece may be of the same or different materials, such as wood, polymeric foam such as styrofoam, cork, etc. FIG. 4A shows a bottom view of lower body piece 50, which includes hollow interior 52. Lower body piece 50 has dimensions including an approximately 12 inch width, 23 inch length (not including tail), and 3 inch height, with central opening 52 having dimensions of 7 to 8 inch width by 12 inch length. FIG. 4B shows a side view of upper body piece 54 attached to lower body piece 50; attachment may be by any desired fastening mechanism such as wood glue or a mechanical fastener. Upper body piece is a solid piece (not hollow) of similar length and width and 3 inch height, attached to lower body piece 50. The total combined height of upper body piece 54 and attached lower body piece 50 is about 6 inches. FIG. 4C illustrates upper and lower body pieces 50 and 54, additionally having headpiece 56 attached at the front of upper body piece 54. An eye (e.g., glass) can be included on head 56, at location 58, if desired, after application of a coating as described. FIG. 4C also illustrates that an optional bottom piece 60 can be attached at the bottom of lower body piece 50; these pieces may also be attached by any desired fastening mechanism such as a wood glue or a mechanical fastening mechanism.

Optional keel 62 may be attached to bottom piece 60. After assembly of pieces including bottom body piece 50, top body piece 54, head 56, and optional bottom piece 60 and keel 62, the assembled pieces may be coated by a coating as described herein.

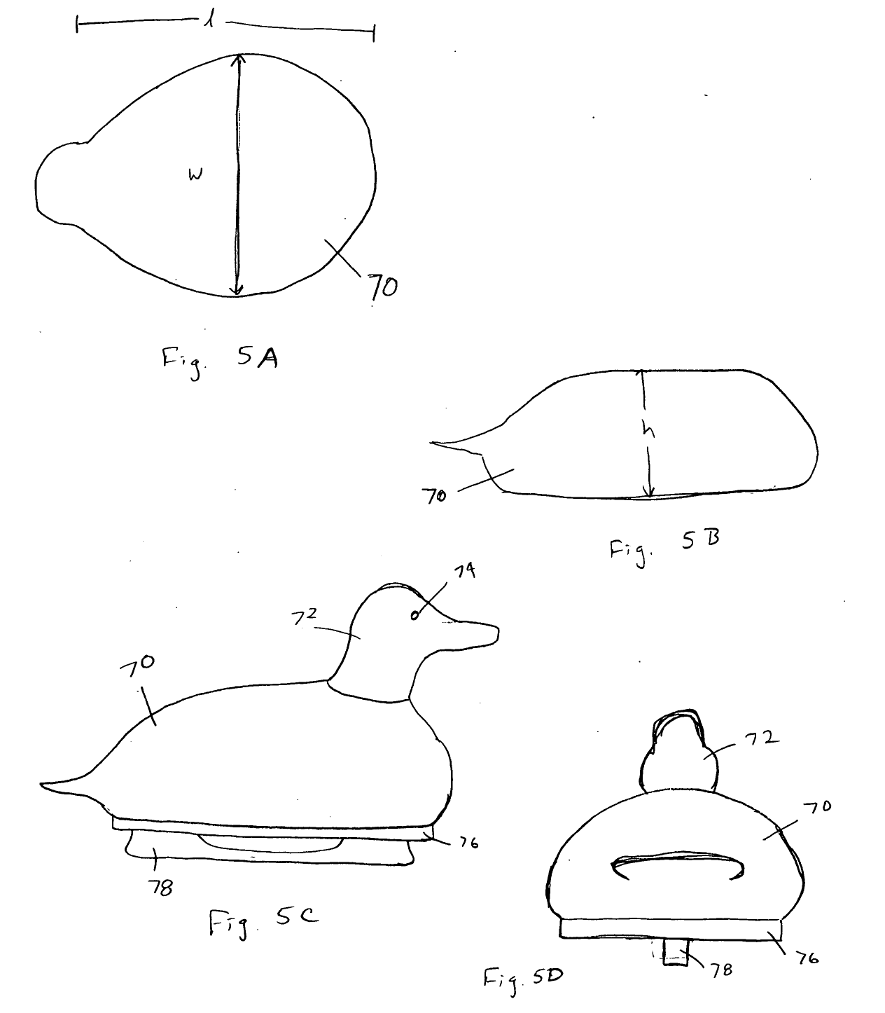

FIGS. 5A, 5B, 5C, and 5D illustrate various views of yet another embodiment of a decoy assembled from multiple pieces. Each piece may be of the same or different materials, such as wood, polymeric foam such as styrofoam, cork, etc. FIG. 5A shows a bottom view of body piece 70, which does not include a hollow interior. Body piece 70 has dimensions including an approximately 11 inch width, 17 inch length, and 3 to 6 inch height. FIG. 5B shows a side view of body piece 70. FIG. 5C illustrates a side view of body piece 70 additionally having headpiece 72 attached. An eye 74 (e.g., glass) can be included on head 72, if desired, after application of a coating as described. FIGS. 5C and 5D illustrate side and rear views showing optional bottom piece 76, of plywood, which can be attached at the bottom of body piece 70; these pieces may be attached by any desired fastening mechanism such as wood glue. Optional keel 78 may be attached to bottom piece 76. After assembly of pieces including body piece 70, head piece 72, and optional bottom piece 76 and keel 78, the assembled pieces may be coated by a coating as described herein.

An example of a type of elastomeric coating that may be useful as a decoy coating is the polymeric material described in U.S. Pat. No. 6,126,999, to Tomasino et al. (“Urethane-Acrylate Rubber Coating and Method of Forming a Vehicle Bed Liner”) (“the '999 patent), the entire disclosure of which is incorporated herein by reference. That description relates to a resilient rubber-based coating derived from a water-curable liquid rubber and a water-based acrylic polymer useful as a vehicle bed liner. The water-curable liquid rubber and the water-based acrylic polymer are combined to form a curing rubber-acrylic composite. The curing composite can be applied onto a substrate and is allowed to completely cure at a temperature in the range of 35 to 110 degrees Fahrenheit, thereby forming the rubber-based coating. The curing rubber-acrylic composite may be applied to a substrate with a spray gun to produce a coating with a thickness in the range of 1 to 15 millimeters.

The liquid rubber may be selected from the group consisting of aliphatic and aromatic isocyanates, natural rubbers, recycled rubbers, styrene butadiene, polybutadiene, polyisoprene, ethylene propylene, chloroprene, acrylonitrile-butadiene, ethylene-propylene, chloroprene, acrylonitrile-butadiene, ethylene-propylenediene monomer, and isopreneisobutylene.

Still referring to the '999 patent, an in-situ coating may be formed by providing a water-curable liquid urethane polymer and a water-based acrylic polymer. The acrylic polymer may be comprised of at least two acrylic polymer compositions. The liquid urethane may be based on the group selected from aliphatic and aromatic isocyanates. The urethane and acrylic polymers are combined to form a curing composite.

A rubber-based urethane for use in a urethane-acrylate rubber based coating can be a moisture-cured, liquid-applied polyurethane. The urethane may be aliphatic or aromatic, such as an aliphatic isocyanate.

Prior to the application of the curing urethane-acrylic composite, the substrate should be clean and free of substantial amounts of oil or debris. The curing composite can be applied to a substrate to thereby form a resilient coating.

Another example of a type of elastomeric bed liner coating that may be useful as a decoy coating is the polymeric material described in U.S. Pat. Nos. 5,814,398 (“In Situ Vehicle Bed Liner and Method of Forming Same”) and 6,539,630 (“Method of Adhesion of In Situ Vehicle Bed Liner”), the entire disclosures of each of these being incorporated herein by reference. These patents describe polyurethanes, polyureas, and hybrid polyurethane/polyurea polymers that reach a gel point almost immediately upon application to a substrate by spraying. The fast-gelling polymer can form a contiguous coating without sagging or running on vertical or highly inclined surfaces. Optionally, a thixotropic agent can be included to further prevent flowing or sagging upon spray application.

Exemplary bedliner materials have been found to exhibit excellent mechanical properties as a spray-coated polymeric material to a desired thickness on a decoy, including properties that result in high strength, durability, and impact resistance. Preferred such materials may be spray-coated to a decoy body to produce a smooth finish with insignificant amounts of runs or drips, if any, on the decoy surface. The surface can also be painted to simulate a waterfowl coloring using a latex or oil-based paint, and the paint is substantially adherent. The polymeric bedliner coating can exhibit great strength in their ability to bear excessive static and dynamic forces in the form of heavy amounts of weight and shotgun fire.

In specific, a buoyant foam duck decoy body was coated using polymeric (polyether-based urethane elastomer) truck bed liner product sold under the brand name ULIMATE bedliners. The two parts were designated 295BX-resin and 2181-ISO (isocyanate). The two-part system is a solvent-free, polyether-based polyurethane elastomer capable of being applied by spraying using known equipment such as a Rhulta 440 spray system.

The two-parts of the polymeric bedliner materials were coated according to product instructions, including application at a temperature between 60 and 80 degrees Fahrenheit. One to two coats were applied, each of approximately 1 to 2 millimeters, over the tops and sides of the decoy bodies, and optionally on bottoms.

For strength testing, a decoy prepared from a styrofoam body coated with the above-referenced ULTIMATE truck bed liner product was placed under the rear wheel of a 2005 model year Nissan Xterra sport utility vehicle. The coating was not perfectly uniform, and covered the sides and top, but not the bottom, which was also flat. The sides were coated with an approximate thickness of from 1 to about 3 millimeters and the back portion of the decoy was coated to an on-average greater thickness of 2 to 4 millimeters. The coated decoy was placed on a cement garage floor and the rear wheel of the sport utility vehicle was driven back-and-forth over the body of the decoy multiple (3) times, stopping during one pass on the center for a period of approximately 5 seconds. The decoy supported the weight of the back wheel when the wheel was held on center. The decoy was undamaged and the coating showed no signs of cracking or breaking, and minimal if any compression vertically. The decoy remained watertight and buoyant, still being capable of floating on water. In contrast, a hollow plastic or an un-coated foam decoy would be expected to experience structural damage in the form of partial or complete breakage or shattering of a hollow plastic decoy, or substantial breakage or compression of an uncoated foam decoy.

For testing for resistance to shotgun fire and subsequent buoyancy, decoys coated as described above were placed on land and a 12-gauge shotgun was fired at the body from approximate distances of 20, 30, and 40 yards. The shotgun barrel was 30 inches in length with a full choke. At 20 yards shells were 3-inch steel shot; some shots penetrated the coating and some did not, but the decoy remained buoyant and still capable of floating normally on water. At 30 yards, shells were 3-inch Federal™ number 5 lead 1-¼ ounce shot; few if any shots penetrated the coating and the decoy remained buoyant and fully capable of floating normally on water. At 40 yards shells were 3-inch bismuth number 4, 1-⅝ ounce shot with a muzzle velocity of 1475 feet; few or no shots penetrated the coating and the decoy remained buoyant and still fully capable of floating normally on water. The form and shape of all decoys were relatively unharmed at all distances with head, neck, bill, and tail of each decoy being intact and un-damaged. In contrast, a hollow plastic or an uncoated foam decoy being shot as described would be expected to experience substantial structural damaged. A hollow plastic decoy may be shattered, broken, or penetrated by shot, in a manner and to an extent that would likely cause the decoy to exhibit lost buoyancy and to no longer float normally if at all. An uncoated foam decoy may remain buoyant but if hit at the tail or head may be damaged structurally by having portions of the decoy such as the head, neck, or tail, become broken and removed from the body; such damage may cause an uncoated foam decoy to be unsuitable for use if a tail, head, neck, bill, or body portion no longer exhibits a shape and form of a duck.

For additional durability testing, duck decoys coated as described above were dropped vertically from heights of at least 3, 4, or 5 feet to hit solid ground with impact to the head, bill, or tail, without breaking. For instance, a foam decoy coated with at least a 2 or 3 millimeter (or greater) coating on the head (including the bill) and neck can be held vertically with the bill facing directly down, and dropped to impact the bill from a height of at least 3, 4, or 5 feet, and upon impact to a solid surface such as cement will not suffer any structural damage. In specific, the bill and head will not be broken or damaged. Alternately or in addition, a decoy coated with at least a 2 or 3 (or greater) millimeter coating on the tail can be held vertically with the tail facing directly down and dropped from a height of at least 5 feet to directly impact the tail, and upon impact to a solid surface such as cement will not suffer any structural damage. In specific, the tail will not be broken or damaged. Coated decoys can also be thrown in the air over 6, 8, 10, or 12 feet, and over a distance of 5, 10, 15, or 20 feet, to impact cement at any portion of the decoy and will also not exhibit structural damage. Ducks as tested weighed about 2 pounds uncoated and about 3 pounds coated, or greater; heavier coated decoys would also be expected to pass this type of dropping and throwing tests without damage to the head, bill, or tail, and while maintaining the ability to float normally. In contrast, a hollow plastic decoy or an uncoated foam or styrofoam decoy may be damaged by such dropping or throwing, normally by breaking at the tail, neck, head, or bill portions. Decoys of other birds or animals such as a goose decoy, turkey decoy, or decoy of another animal, will exhibit similar improved durability over plastic or uncoated foam decoys.

1. A game decoy comprising
a decoy body mimicking a shape of a game animal, and
a coating on the body comprising elastomeric polymer. wherein the coating is an elastomeric coating that exhibits the following mechanical properties

| | |
|---|---|
| Shore A hardness (ASTM-D 2440) | 80 to 95 A (50D); |
| Tensile strength (ASTM-D 412) | 2000 to 2500 pounds per square |
| | inch; and |
| Elongation at break (ASTM-D 412) | 200 percent to 600 percent |
| Tear Strength (ASTM-D 624) | 400 to 900 and pounds per square |
| | inch. |

2. The decoy of claim 1 wherein the body comprises a material selected from the group consisting of cork, a polymeric foam, and wood.

3. The decoy of claim 1 wherein the coating is an elastomeric coating that exhibits elongation and tensile strength of a hardened, sprayed-on, two-part vehicle bed liner.

4. The decoy of claim 1 wherein the coating is an elastomeric coating that exhibits one or any combination or two or more of the following mechanical properties:

| | |
|---|---|
| Shore A hardness (ASTM-D 2440) | 80 to 95 A (50D); |
| Tensile strength (ASTM-D 412) | 2000 to 2500 pounds per square |
| | inch; and |
| Elongation at break (ASTM-D 412) | 200 percent to 400 percent. |
| Tear Strength (ASTM-D 624) | 400 to 460 pounds per square inch. |

5. The decoy of claim 1 wherein the coating comprises polymer derived from isocyanate compound.

6. The decoy of claim 1 wherein the coating comprises polymer derived from multi-functional isocyanate, and polyol.

7. The decoy of claim 1 wherein the coating comprises polymer selected from the group consisting of: a polyurethane, a polyurea, and a mixture of polyurethane and polyurea.

8. The decoy of claim 1 wherein the coating has an average thickness where applied to the decoy in the range from 1 to 10 millimeters.

9. The decoy of claim 1 wherein the coating is derived from a two-part polymeric mixture containing 100 percent solids.

10. The decoy of claim 1 wherein the decoy body comprises a body piece and a headpiece, and the coating mechanically secures the headpiece to the body piece.

11. The decoy of claim 1 wherein the decoy body comprises multiple body pieces adhered together with adhesive and the coating.

12. A method of preparing a game decoy, the method comprising
providing a decoy body mimicking a shape of a game animal,
providing a liquid polymeric composition, which can harden to comprise an elastomeric polymer,
applying the liquid polymeric composition onto the body and allowing the polymeric composition to harden as a polymeric coating, wherein the hardened coating is an elastomeric coating that exhibits the following mechanical properties

| | |
|---|---|
| Shore A hardness (ASTM-D 2440) | 80 to 95 A (50D); |
| Tensile strength (ASTM-D 412) | 2000 to 2500 pounds per square |
| | inch; and |
| Elongation at break (ASTM-D 412) | 200 percent to 600 percent |
| Tear Strength (ASTM-D 624) | 400 to 900 and pounds per square |
| | inch. |

13. The method of claim 12 wherein the liquid polymeric composition comprises a mixture of two polymeric materials, and the two polymeric materials are mixed and applied by spraying the mixture of two polymeric materials to a surface of the body.

14. The method of claim 12 wherein the hardened polymeric coating comprises polymer selected from the group consisting of a polyurethane, a polyurea, and a combination thereof.

15. The method of claim 12 wherein providing a polymeric composition comprises
providing a first polymeric part comprising polyol,
providing a second polymeric part comprising multi-functional isocyanate,
combining the first and second parts to form a polymeric mixture, and
spraying the polymeric mixture as a coating at a surface of the body.

16. The method of claim 15 wherein the first part and the second part are 100 percent solids.

17. The method of claim 15 wherein the first and second parts are combined and sprayed, and harden to a tack-free coating within 60 seconds of spraying.

18. The method of claim 13 wherein the polymeric coating is applied to vertical surfaces of the decoy body without running, forming a surface that is dry and hard to the touch within 60 seconds.

19. The method of claim 12 comprising
providing a decoy headpiece and a decoy body piece,
assembling the decoy pieces by placing the headpiece at a front location of the body to produce a decoy having a shape of a game animal,
applying the liquid polymeric composition onto the assembled decoy including the headpiece and the body piece and allowing the polymeric composition to harden as an elastomeric polymeric coating, wherein the coating mechanically secures the headpiece to the main body piece.

20. A method of preparing a game decoy according to claim 12, the method comprising
providing multiple decoy pieces,
assembling the decoy piece to produce a decoy having a shape of a game animal,
providing a liquid polymeric composition that can harden to comprise an elastomeric polymer,
applying the liquid polymeric composition onto a surface of the assembled decoy pieces, wherein the coating mechanically secures the pieces together in the form of a game animal.
